(19) United States
(12) Patent Application Publication
(10) Pub. No.: US 2002/0107698 A1
(43) Pub. Date: Aug. 8, 2002

(54) Apparatus, methods and computer programs for determining estimated impact of proposed legislation

(75) Inventors: Michael Wayne Brown, Georgetown, TX (US); Rabindranath Dutta, Austin, TX (US); Michael A. Paolini, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/779,356

(22) Filed: Feb. 8, 2001

(51) Int. Cl. G06F 17/60

(52) U.S. Cl. 705/1; 705/7; 705/30

(57) ABSTRACT

Apparatus, methods and computer programs by which the impact on a user of a proposed change in legislation may be determined are provided. The apparatus and methods calculate a change in a user's state based on legislation data downloaded from a policy maker system. Based on the user's change in state, an electronic mail message may be generated and sent to appropriate parties in order to voice the user's support or non-support of the proposed legislation as well as provide the appropriate parties with information about how the proposed legislation will affect the user. For example, a user's estimated tax liability under proposed changes to a tax code can be calculated and compared to previous year s tax liability. Based on the comparison, an estimated change in tax liability may be determined so that the user may be informed of how the proposed tax legislation will affect him/her. An electronic mail message may then be generated and sent to proponents of the proposed tax legislation, the user's elected representatives, and appropriate regulatory agencies in order to voice the user's support or non-support of the proposed tax legislation.

### TECHNICAL FIELD

The present invention is directed to an improved distributed computer system. More particularly, the present invention provides apparatus, methods and computer programs for determining an estimated impact of proposed legislation.

### DESCRIPTION OF RELATED ART

Software applications for determining tax liability based on a current status of the tax code and a user's financial data are generally known in the art. With such applications, a user may, with the aid of a computer, generate necessary forms for filing an income tax return with the Internal Revenue Service. However, these applications do not provide any ability for a user to determine what his/her tax liability may be under proposed changes to the tax code. Thus, it would be beneficial to have an apparatus and method for determining a user's estimated tax liability under proposed tax legislation so that the user may determine whether or not to support the proposed legislation and/or the proponent of the legislation.

### SUMMARY OF THE INVENTION

The present invention provides apparatus and methods by which the impact on a user of a proposed change in legislation may be determined. The present invention calculates a change in a user's state based on legislation data downloaded from a policy maker system. Based on the user's change in state, an electronic mail message may be generated and sent to appropriate parties in order to voice the user's support or non-support of the proposed legislation as well as provide the appropriate parties with information about how the proposed legislation will affect the user.

For example, the present invention may be used to calculate a user's estimated tax liability under proposed changes to a tax code. The calculated estimated tax liability can then be compared to a previous year's tax liability for the user. Based on the comparison, an estimated change in tax liability may be determined so that the user may be informed of how the proposed tax legislation will affect him/her. An electronic mail message may then be generated and sent to proponents of the proposed tax legislation, the user's elected representatives, and appropriate regulatory agencies in order to voice the user's support or non-support of the proposed tax legislation.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a network data processing system according to one embodiment of the present invention;

FIG. 2 is an exemplary block diagram illustrating a server device according to one embodiment of the present invention;

FIG. 3 is an exemplary block diagram illustrating a client device according to one embodiment of the present invention;

FIG. 4 is an exemplary block diagram illustrating data flow between primary components of the network data processing system of FIG. 1 according to one embodiment of the present invention; and

FIG. 5 is a flowchart outlining an exemplary operation of the present invention when determining an estimated tax liability based on proposed tax legislation.

### DETAILED DESCRIPTION OF THE PREFERRED EMBODIMENT

The present invention provides a mechanism by which the impact of proposed legislation on a user may be calculated and provided to a user for his/her information. Based on the calculation, the user may decide to either support or not support the proposed legislation. Furthermore, the user may have an electronic mail message automatically generated indicating the user's support, or lack thereof, for the proposed legislation along with an indication of the impact of the proposed legislation on the user.

While the present invention may be applied to any type of legislation whose impact on a user may be quantitatively determined, the present invention will be described in terms of a preferred embodiment directed to the determination of the impact of proposed tax legislation on a user's estimated tax liability. It should be appreciated that this embodiment is chosen only for illustrative purposes and is not meant to be limiting in any way. It should also be appreciated that the present invention may be applied to various types of proposed legislation, such as legislation affecting Medicaid, IRA contributions, Thrift Savings Plan contributions, real estate taxes, school district legislation, funding for city road maintenance, and the like.

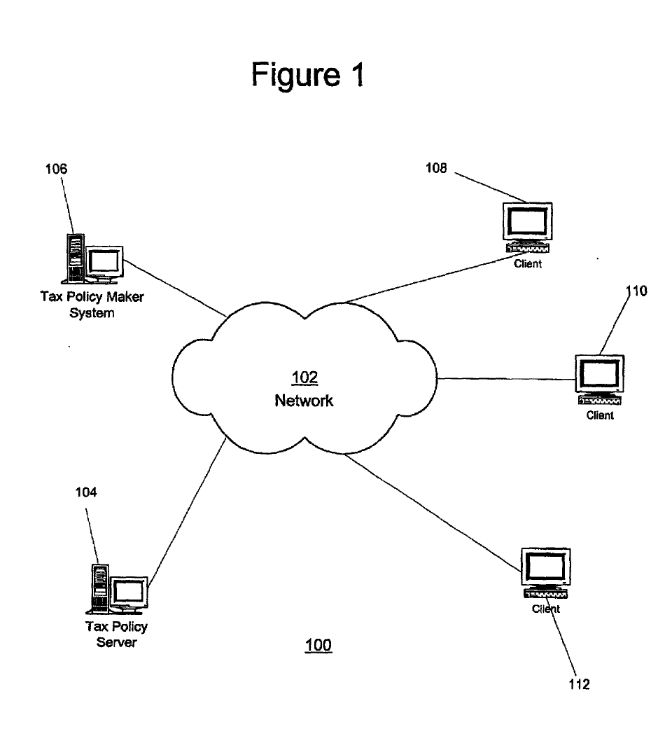

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, client devices 108-112 are connected to network 102 along with tax policy server 104 and tax policy maker system 106. Although a “tax” policy server 104 and “tax” policy maker system 106 are depicted in the Figures, as mentioned above, the present invention is not limited to an application to proposed tax change legislation. Other types of policy servers 104 and policy maker systems 106 may be used with the present invention depending on the particular implementation of the invention. For purposes of illustration, however, the preferred embodiments of the present invention will be described in terms of tax policy servers 104 and tax policy maker systems 106.

The client devices 108-112 may be, for example, personal computers, network computers, personal digital assistants, portable computing devices, or the like. In the depicted example, server 104 provides data, such as files, web pages, operating system images, and applications to client devices 108-112. Client devices 108-112 are clients to server 104. Network data processing system 100 may include additional servers, clients, service providers and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN).

FIG. 1 is intended as an example, and not as an architectural limitation for the present invention. The tax policy maker system 106 is a computer system associated with an entity responsible for generating and promulgating proposed tax legislation. For example, the tax policy maker system 106 may be a system associated with a political candidate's campaign office, a legislative body's home page, a web site associated with the Internal Revenue Service, or the like. The tax policy maker system 106 provides information identifying proposed legislation that affects the tax code or the way in which taxes are calculated. While only one tax policy maker system 106 is depicted in FIG. 1 for simplicity, in actuality there may be many different tax policy maker systems 106. Alternatively, the tax policy maker system 106 may provide information on more than one piece of proposed tax legislation.

The tax policy server 104 is a server that maintains information regarding the various pieces of proposed tax legislation compiled from one or more tax policy maker systems 106. The tax policy information may be entered by an administrator of the tax policy server 104, for example, based on the proposed tax legislation information obtainable from the tax policy maker system 106. The tax policy information may address individual features of proposed tax legislation, an entire piece of proposed tax legislation, or pieces of various proposed tax legislation.

The tax policy information stored on the tax policy server 104 is preferably stored in a format that is recognizable and parsable by an estimated tax liability determination device associated with the various client devices 108-112. When a user of a client device, such as client device 108, wishes to determine how a piece of proposed tax legislation will affect the amount of taxes that he/she will be required to pay, the user may log onto an appropriate web site supported by the tax policy server 104.

Upon logging onto the tax policy server's web site, the user may select the particular proposed tax legislation, or portions thereof, that he/she is interested in and download the tax policy information for that proposed tax legislation to his/her client device 108. The downloaded tax policy information is then used by an estimated tax liability determination device associated with the client device 108 to estimate what the user's tax liability will be under the proposed tax legislation. This tax liability may then be compared to the user's last year tax liability to determine the relative affect on the user of the proposed tax legislation.

Based on the relative affect on the user, the user may decide to contact the tax policy maker to voice his/her opinion regarding the proposed tax legislation, either for or against it. The present invention provides a mechanism by which the user may select an option for contacting one or more appropriate entities, such as tax policy makers, to voice his/her opinion regarding the proposed tax legislation. The present invention may automatically generate an electronic mail message that is automatically addressed to the proponent of the proposed tax legislation, the user's congressman (or other pertinent elected official), and the tax regulatory agency, and other appropriate entities. The particular entities to which the electronic mail message is address do not have to be government entities and may be, for example, watchdog groups, commercial entities, other users, or any other entity that may be interested in knowing the impact of the proposed legislation on the user.

Furthermore the content of the message may be automatically generated based on a user's selection of whether he/she is for or against the proposed tax legislation. Alternatively, if the relative affect of the tax legislation on the user is determined to increase the user's tax liability, it may be automatically assumed that the user is against the proposed tax legislation whereas if the user's tax liability is reduce, it may automatically be assumed that the user is for the proposed tax legislation. In addition, the present invention may automatically import data identifying the relative affect of the proposed legislation on the user's tax liability into the body of the electronic mail message.

The one or more entities that receive the electronic mail message may, for example, log the electronic mail message as a separate message, or may accumulate the information in the electronic mail message with other electronic mail messages already received. The accumulation of the information in the electronic mail message with other electronic mail messages already received may be performed in an anonymous or semi-anonymous manner by eliminating or partially eliminating identifying information from the data maintained by the system associated with the one or more entities.

For example, the tax policy maker system may receive the electronic mail message, extract the tax liability information from the electronic mail message and add it to tax liability information already obtained by the tax policy maker system. In this way, a proponent of the proposed tax legislation may obtain and accumulate data from users indicating the way in which the proposed tax legislation will affect the users. Thus, the proponent may use this accumulated data to support the proposed tax legislation or as a mechanism for changing identifying areas in which the proposed tax legislation should be changed.

Thus, the present invention provides a mechanism by which a user may determine the estimated affect of proposed tax legislation on his/her tax liability. Furthermore, the present invention provides a mechanism by which a user may automatically generate an electronic mail message to the proponent of the proposed tax legislation, the user's elected officials, and the tax regulatory agency, indicating the user's opinion regarding the proposed tax legislation and the estimated affect on his/her tax liability.

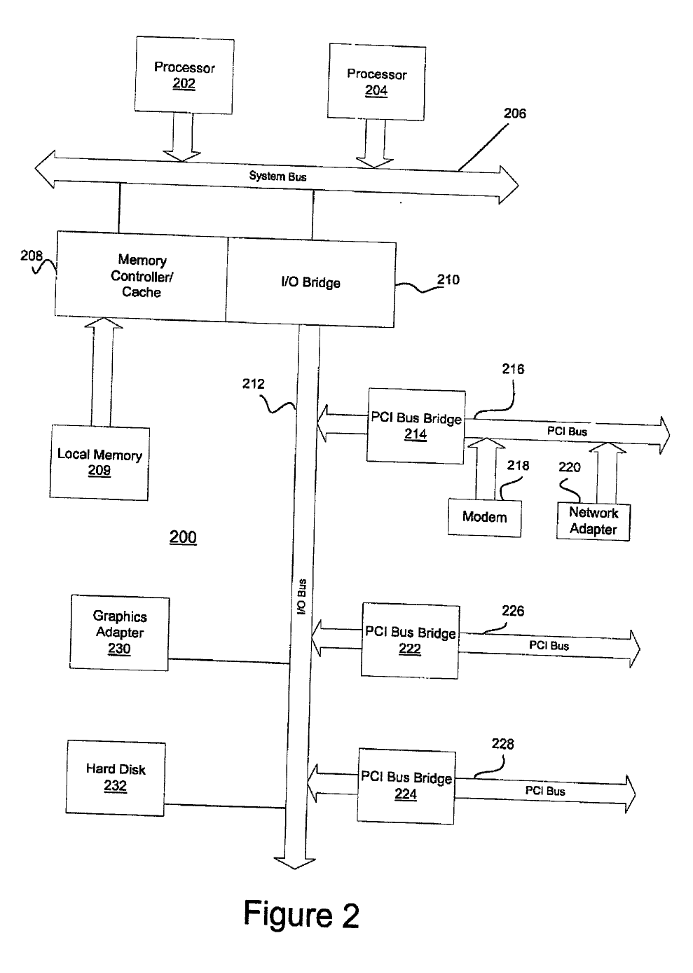

Referring to FIG. 2, a block diagram of a data processing system that may be implemented as a server, such as tax policy server 104 or tax policy maker system 106 may be resident, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIGS. 1A and 1B may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, New York, running the Advanced Interactive Executive (AIX) operating system.

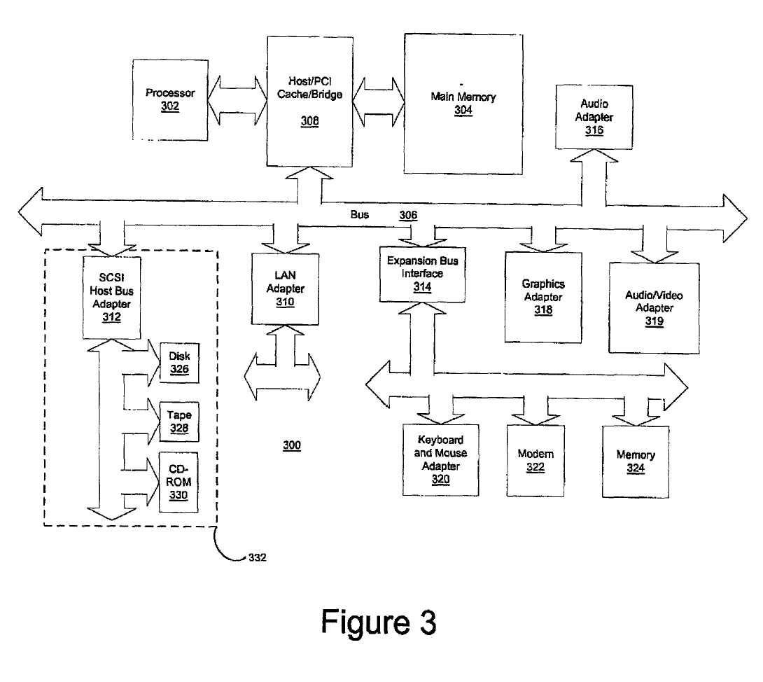

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

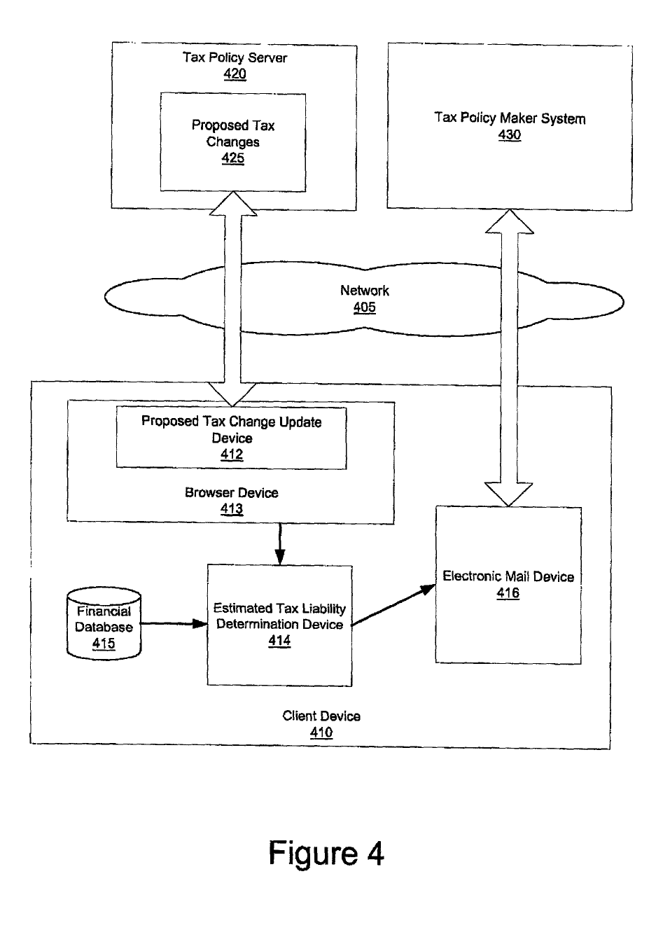

FIG. 4 is an exemplary block diagram illustrating the data flow among the primary components of the present invention. As shown in FIG. 4, the client device 410 includes a proposed tax change update device 412, a determination device 414, a financial database 415, and an electronic mail device 416. The tax policy server 420 includes proposed tax code change data 425 representing proposed tax legislation. The elements 412-416 and 425 may be implemented as hardware devices, software resident on the client device 410 and tax policy server 420, respectively, or as a combination of hardware and software.

The client device 410 communicates with the tax policy server 420 via the network 405 in a manner generally known in the art. For example, the client device 410 may make use of the TCP/IP suite of Internet protocols for communicating with the tax policy server 420.

A user of the client device 410 may enter a request for proposed tax code changes via the proposed tax change update device 412 which is associated with the browser device 413. The proposed tax change update device 412 may be, for example, a part of the browser device 413, a plug-in device to the browser device 413, or may be a separate device in communication with the browser device 413. The proposed tax change update device 412 receives the user input and generates a request for tax change data from the tax policy server 420. The proposed tax change update device 412 then transmits the request, using an appropriate communication protocol, via the network 405 to the tax policy server 420.

The tax policy server 420 receives the request for the proposed tax change data, identifies the proposed tax change data 425 corresponding to the request, and transmits the proposed tax change data 425 to the client device 410. The proposed tax change data 425 is preferably in a format that is recognizable and useable by the estimated tax liability determination device 414. However, the present invention may receive the proposed tax change data 425 in any format and reformat the proposed tax change data 425 in the proposed tax change update device 412 so that it is in a proper format for use by the estimated tax liability determination device 414.

The proposed tax change data 425 received by the proposed tax change update device 412 may be imported into the estimated tax liability determination device 414 and used as a basis for calculating an estimated tax liability for the user. The estimated tax liability determination device 414 may apply the proposed tax change data 425 along with the unchanged tax code to financial data obtained from financial database 415 to calculate the user's estimated tax liability based on the proposed tax legislation. Alternatively, the necessary user financial information may be input by the user via an input device associated with the client device 410.

Once the financial data for the user is obtained and the proposed tax change data 425 is imported, the estimated tax liability determination device 414 may calculate an estimated tax liability for the user based on the proposed tax legislation as it is represented in the downloaded proposed tax change data 425. The calculation of a tax liability based on financial data and a currently existing tax code is generally known in the art. Software programs, such as TurboTax™, are widely known for their ability to prompt users for financial information and then using that financial information to calculate an amount of taxes or refund owed.

The estimated tax liability determination device 414 may make use of a tax liability calculation engine, similar to TurboTax™ or the like, to perform the specific calculation of the tax liability. However, the present invention updates the data representing the tax code within the tax liability calculation engine based on the downloaded proposed tax change data prior to calculating the tax liability in order to obtain an estimated tax liability under the proposed tax legislation.

The estimated tax liability calculated by the estimated tax liability determination device 414 may then be compared to prior tax return information stored in the financial database 415 to determine a change in tax liability for the user. Thus, if a user paid $10,000 in taxes in the year 2000 and the proposed tax legislation would cause the user to pay $13,000 in taxes in the year, an estimated change in tax liability of +$3000 is calculated.

Based on the estimated change in the tax liability determined by the estimated tax liability determination device 414, a user may decide whether or not he/she is in favor of the proposed tax legislation. The user may then enter a command into the client device 410 instructing the estimated tax liability determination device 414 to generate an electronic mail message to be sent to one or more parties indicating either the user's support or disfavor of the proposed tax legislation.

In response to receiving the command to generate the electronic mail message, the estimated tax liability determination device 414 may communicate with an electronic mail device 416 to construct an electronic mail message. The estimated tax liability determination device 414 may construct the electronic mail message by issuing a command to the electronic mail device 416 to create a new electronic mail message, insert specific electronic mail message addresses, and then insert a standardized electronic mail message based on whether the user is in favor of the proposed tax legislation.

For example, the estimated tax liability determination device 414 may instruct the electronic mail device 416 to create a new mail message and insert into the “To” field the electronic mail addresses for the proponent of the proposed tax legislation, the user's elected representatives, and/or the regulatory body responsible for collection of the tax. The various electronic mail messages may be stored in the estimated tax liability determination device 414, may be downloaded from the tax policy server 420 with the proposed tax change data 425, entered by the user, or any combination of the above.

The standardized electronic mail message may be text data stored in the estimated tax liability determination device 414 which is pasted into an electronic mail message, for example. The particular text will be dependent on whether the user is for or against the proposed tax legislation. Thus, for example, if the user is for the proposed tax legislation, the text of the electronic mail message may be:

To Whom it May Concern:

I have reviewed the proposed tax legislation and have determined that it will benefit me by reducing my tax burden by $______ per year at my current financial status. As a result, I wish to inform you of my support for this proposed legislation.

Alternatively, if the user is against the proposed tax legislation, the text of the electronic mail message may be:

To Whom it May Concern:

I have reviewed the proposed tax legislation and have determined that it will increase my tax burden by $______ per year at my current financial status. As a result, I wish to inform you that I do not support the passing of this proposed legislation.

The blank dollar amounts in the standardized text messages may be automatically filled by the estimated tax liability determination device 414 with the estimated change in tax liability calculated by the estimated tax liability determination device 414. Once the electronic mail message is created, the estimated tax liability determination device 414 may issue a command to the electronic mail device 416 to send the electronic mail message to the entities identified in the “To” fields. The electronic mail message is then routed through the network 405, in a manner generally known in the art, to the tax policy maker systems 430 included in the addresses in the “To” field of the electronic mail message.

Once received by the tax policy maker systems 430, the estimated change in tax liability included in the electronic mail message may be extracted and accumulated with other estimated changes in tax liability obtained from other electronic mail messages from other users. In this way, a proponent, supporter, or other interested entity, of the proposed tax legislation may be informed of the general affect of the proposed legislation on users. In this way, changes to the proposed legislation may be made to address concerns of the users and/or data in support of the proposed legislation may be obtained for use by the various interested entities.

While FIG. 4 depicts the elements 412 and 414-416 as being resident in association with a client device 410, the invention is not limited to such an architecture. Rather, the present invention may be embodied in a system in which one or more of the proposed tax change update device 412, the estimated tax liability determination device 414, the financial database 415, and the electronic mail device 416 may be located remotely from the client device 410 such as on tax policy server 420, a proxy server (not shown) or otherwise distributed in network data processing system 100 of FIG. 1, for example.

For example, the client device 410 may make use of the browser device 413 to retrieve one or more web pages from servers of the network 405. These web pages may be associated with one or more of the tax change update device 412, the estimated tax liability determination device 414, the financial database 415, and the electronic mail device 416. The user may enter information and requests via fields in the web pages and receive results of estimated tax liability calculations in the form of additional Hypertext Transfer Markup Language (HTML) documents downloaded to the client device 410. Thus, a user of the client device 410 may access the same functionality of the various devices 412, 414-416 via a local browser device 413 and web pages associated with the devices 412, 414-416.

Furthermore, the financial data and estimated tax liability data used by the present invention may be maintained entirely in the client device or may be shared with a remotely located server that performs the functions of the present invention. In this way, if the data is kept at the client device, privacy of the user may be secured. Alternatively, if the data is shared with a remotely located server, the transfer of the data to the server may be performed over a secure connection to minimize the possibility of interception by third parties.

In addition, while the above embodiments describe the invention in terms of a user initiating the sending of an electronic mail message to appropriate parties associated with the proposed tax legislation, the present invention does not require the user to initiate the sending of the electronic mail message. Rather, the present invention may automatically generate and send the electronic mail message based on the results of the determination of the estimated change in tax liability. That is, for example, the present invention may assume that a user whose tax liability increases will not be in favor of the proposed tax-legislation and therefore, generates and sends an electronic mail message accordingly. Of course, a user's confirmation may be solicited before the message is actually sent.

The process described above with regard to FIG. 4 may be performed for any number of proposed tax legislations. Thus, the proposed tax change data 425 downloaded from the tax policy server 420 may contain data for a number of different proposed tax legislations. The present invention may determine the estimated tax liability under each of the proposed tax legislations, report the results to the user, and automatically send electronic mail messages to appropriate parties based on the user's favor or disfavor of the proposed legislation.

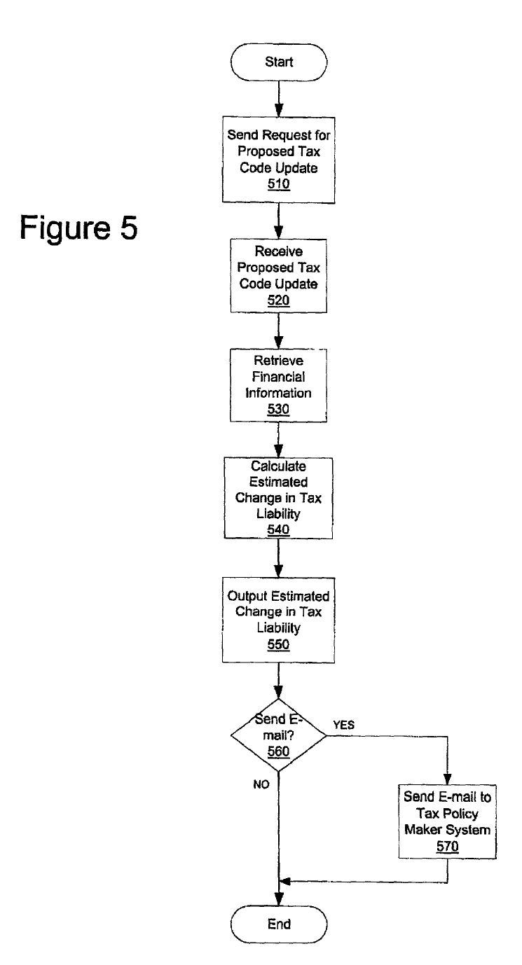

FIG. 5 is a flowchart outlining an exemplary operation of the present invention. As shown in FIG. 5, the operation starts by sending a request for proposed tax code update data to the tax policy server (step 510). The proposed tax code update data is received (step 520) and the financial information for the user is retrieved (step 530). The estimated tax liability of the user under the proposed tax code is calculated and compared to a previous tax return of the user to determine an estimated change in tax liability of the user (step 540). The estimated change in tax liability for the user is output (step 550) and it is determined whether to send an electronic mail message based on the estimated change in tax liability for the user (step 560). If an electronic mail message is to be sent, the electronic mail message is generated and sent to the tax policy maker system (step 570). Otherwise, the operation ends.

Thus, the present invention provides a mechanism by which a user's estimated tax liability under proposed changes to the tax code can be calculated and compared to previous year's tax liability. Based on this comparison, an estimated change in tax liability may be determined so that the user may be informed of how the proposed tax legislation will affect him/her. An electronic mail message may then be generated and sent to proponents of the proposed tax legislation, the user's elected representatives, and appropriate regulatory agencies in order to voice the user's support or non-support of the proposed tax legislation.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMS, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of estimating an impact of proposed legislation on a user, comprising:
obtaining proposed legislation data;
calculating an affect of the proposed legislation based on the proposed legislation data; and
outputting the affect of the proposed legislation.

2. The method of claim 1, wherein the proposed legislation data represents proposed changes to a tax code.

3. The method of claim 1, wherein calculating an affect of the proposed legislation includes calculating an estimated change in tax liability by calculating an estimated tax liability based on the proposed legislation data and comparing the estimated tax liability to a previous tax liability.

4. The method of claim 1, further comprising:
generating an electronic mail message based on the affect of the proposed legislation; and
transmitting the electronic mail message to one or more remote devices.

5. The method of claim 4, wherein the electronic mail message indicates one of a user's support or non-support of the proposed legislation.

6. The method of claim 4, wherein the electronic mail message is automatically generated.

7. The method of claim 4, wherein the affect of the proposed legislation is automatically inserted into the electronic mail message.

8. The method of claim 4, wherein the electronic mail message is automatically addressed to the one or more remote devices.

9. The method of claim 3, wherein calculating an estimated tax liability based on the proposed legislation data includes:
updating a tax calculation engine based on the proposed tax legislation data;
obtaining financial data for the user; and
applying the updated tax calculation engine to the financial data.

10. The method of claim 1, wherein the proposed tax legislation data is obtained from a server, and wherein the method is implemented in a client to the server.

11. The method of claim 8, further comprising downloading one or more addresses for the one or more remote devices.

12. The method of claim 7, wherein the affect of the proposed legislation included in the electronic mail message is accumulated with other affects of the proposed legislation included in other electronic mail messages received by the one or more remote devices.

13. An apparatus for estimating an impact of proposed legislation on a user, comprising:
means for obtaining proposed legislation data;
means for calculating an affect of the proposed legislation based on the proposed legislation data; and
means for outputting the affect of the proposed legislation.

14. The apparatus of claim 13, wherein the proposed legislation data represents proposed changes to a tax code.

15. The apparatus of claim 13, wherein the means for calculating an affect of the proposed legislation includes:
means for calculating an estimated change in tax liability by calculating an estimated tax liability based on the proposed legislation data; and
means for comparing the estimated tax liability to a previous tax liability.

16. The apparatus of claim 13, further comprising:
means for generating an electronic mail message based on the affect of the proposed legislation; and
means for transmitting the electronic mail message to one or more remote devices.

17. The apparatus of claim 16, wherein the electronic mail message indicates one of a user's support or non-support of the proposed legislation.

18. The apparatus of claim 16, wherein the electronic mail message is automatically generated.

19. The apparatus of claim 16, wherein the affect of the proposed legislation is automatically inserted into the electronic mail message.

20. The apparatus of claim 16, wherein the electronic mail message is automatically addressed to the one or more remote devices.

21. The apparatus of claim 15, wherein the means for calculating an estimated tax liability based on the proposed legislation data includes:
means for updating a tax calculation engine based on the proposed tax legislation data;
means for obtaining financial data for the user; and
means for applying the updated tax calculation engine to the financial data.

22. The apparatus of claim 13, wherein the proposed tax legislation data is obtained from a server, and wherein the apparatus is implemented in a client to the server.

23. The apparatus of claim 20, further comprising means for downloading one or more addresses for the one or more remote devices.

24. The apparatus of claim 19, wherein the affect of the proposed legislation included in the electronic mail message is accumulated with other affects of the proposed legislation included in other electronic mail messages received by the one or more remote devices.

25. A computer program product in a computer readable medium for estimating an impact of proposed legislation on a user, comprising:
first instructions for obtaining proposed legislation data;
second instructions for calculating an affect of the proposed legislation based on the proposed legislation data; and
third instructions for outputting the affect of the proposed legislation.

26. The computer program product of claim 25, wherein the proposed legislation data represents proposed changes to a tax code.

27. The computer program product of claim 25, wherein the second instructions include instructions for calculating an estimated change in tax liability by calculating an estimated tax liability based on the proposed legislation data and instructions for comparing the estimated tax liability to a previous tax liability.

28. The computer program product of claim 25, further comprising:
fourth instructions for generating an electronic mail message based on the affect of the proposed legislation; and
fifth instructions for transmitting the electronic mail message to one or more remote devices.

29. The computer program product of claim 28, wherein the electronic mail message indicates one of a user's support or non-support of the proposed legislation.

30. The computer program product of claim 28, wherein the electronic mail message is automatically generated.

31. The computer program product of claim 28, wherein the affect of the proposed legislation is automatically inserted into the electronic mail message.

32. The computer program product of claim 28, wherein the electronic mail message is automatically addressed to the one or more remote devices.

33. The computer program product of claim 27, wherein the instructions for calculating an estimated tax liability based on the proposed legislation data includes:
instructions for updating a tax calculation engine based on the proposed tax legislation data;
instructions for obtaining financial data for the user; and
instructions for applying the updated tax calculation engine to the financial data.

34. The computer program product of claim 25, wherein the proposed tax legislation data is obtained from a server, and wherein the computer program product is executed in a client to the server.

35. The computer program product of claim 32, further comprising sixth instructions for downloading one or more addresses for the one or more remote devices.

36. The computer program product of claim 31, wherein the affect of the proposed legislation included in the electronic mail message is accumulated with other affects of the proposed legislation included in other electronic mail messages received by the one or more remote devices.
